(19) United States
(12) Patent Application Publication
(10) Pub. No.: US 2026/0101876 A1
(43) Pub. Date: Apr. 16, 2026

(54) TEMPERATURE SENSING EAR TAG AND BASED SYSTEM

(71) Applicant: Medisim, LTD., Beit-Shemesh (IL)

(72) Inventors: Moshe Yarden, Shoresh (IL); IIan Vadai, Hod Hasharon (IL)

(73) Assignee: Medisim, LTD., Beit-Shemesh (IL)

(21) Appl. No.: 19/358,809

(22) Filed: Oct. 15, 2025

Related U.S. Application Data
(60) Provisional application No. 63/707,386, filed on Oct. 15, 2024.

(51) Int. Cl. A01K 29/00; A01K 11/00

(52) U.S. Cl. CPC A01K 29/005; A01K 11/004

(57) ABSTRACT

Disclosed are a system, device, and process for monitoring physical and physiological features of livestock and their location through a unique device having a piercing member either integral or separate from a tag and having a temperature sensor in contact with tissue of a mammal having the tag attached thereto. Achieved are at least the following improvements using the present disclosure: good contact of a temperature sensor with the earlobe to capture heat, protection of the sensor from external mechanical strain, and efficient manufacturability. The present disclosure also provides a mechanical arrangement of an animal ear tag which comprises, a temperature sensor disposed against the earlobe, encapsulated in a protruding section of the tag. The sensor is pressed against the animal’s earlobe when the tag is mounted on the ear. The location device may be mobile or stationary.

### CROSS-REFERENCE TO RELATED APPLICATIONS

The present US Non-Provisional Patent application incorporates by reference the disclosure of U.S. Provisional Patent Application No. 63/707,386 filed October 15, 2024, the disclosure of which is hereby incorporated herein by reference.

### FIELD OF USE

The present disclosure relates to a temperature sensing ear tag attached to an animal, and more particularly to a radio frequency tag on an animal or livestock to assist in identifying and locating certain animals, their health state, or a combination of the previously mentioned.

The present disclosure also relates to a system and methods for attaching a temperature sensing ear tag to an animal that incorporates an encapsulated sensor that contacts the tissue of the animal.

### BACKGROUND OF THE INVENTION

In recent times, the size of farms/ranches and livestock herds have increased drastically, and the ability of farmers/ranchers to personally monitor the condition of their livestock herds has also grown in difficulty and expense. Human visual observation to monitor the health, fertility and condition of individual animals has become impractical and cost-prohibitive due to the large number of animals and vast distances encompassing a farm/ranch. In response to these evolving conditions, some farmers/ranchers have turned towards performing such monitoring and/or managing through the use of electronic tags associated with individual animals.

Electronic documentation and verification involves the use of machine readable/writeable tags, in the manner of conventionally known ear tags, to be implanted or internally carried by the animal. Such tags may be tied to a database identifying and recording various events during the livestock production and processing cycle, for instance, the receipt of livestock at a feedlot from another facility, medicines or other treatments applied, feeding protocols, shipping, and meat processing.

Particularly, the use of machine-readable radio frequency identification (“RFID”) tags enables some automation of recognizing the presence of a specific animal within the range of an RFID interrogator. However, RFID tags have a limited range, requiring an animal to be contained within a squeeze chute or other restraint for identification and assurance of a reliable tag reading. Unfortunately, in the real-world such methods are impractical, time-consuming, and require additional personnel.

Again a radio frequency (RF) device worn by an animal in the field may be used to identify and localize the animal. The RF devices however should function under harsh conditions and for a long time such as years without the need for intermediate recharging and/or maintenance. Therefore, energy-consuming localization techniques such as GPS or the like cannot be used.

Furthermore, RF devices will not have a continuous connection to the base station for continuously transmitting data to a base station. Instead, in order to reduce energy consumption, if an RF device is within the area that is covered by a base station, it will transmit collected data at regular time intervals to a base station. Typically, base stations are sparsely divided over the area and the animals are usually allowed to move freely over a relatively large area.

Thus, localization on an animal on the basis of a triangulation technique using received signals by different base stations is not possible. In that case, only very course positioning is possible using for example the location of the base station a RF device that was most recently was connected.

In addition, detection of broadcasting RF devices in the GHz range using a single-point mobile receiver is not evident. The RF devices typically are equipped with a small antenna elements which have a non-homogenous, direction-sensitive radiation pattern. Further, the GHz radiation transmitted by a RF device can be partly absorbed by the body of the animal or neighboring animals and/or it can be scattered by obstacles causing multi-path interference and signal scattering effects.

Additionally, a RF device is connected to a moving body part, e.g., an ear, while at the same time also the animal can move and turn. These movements and all other effects described above will cause substantial fluctuations in the signal received by the mobile radio receiver.

In some prior attempts, U.S. Patent 9,848,577 and US10,130265 disclose a temperature sensor within the shaft assembly (“heat pipe”) of the piercing mechanism to obtain an ear temperature measurement of the animal. Incorporation of a sensor inside the piercing shaft is cumbersome. Although the shaft protects the sensor from mechanical damage when piercing the ear as the shaft is placed through the pierced hole of the animal, however, structural confines of the shaft limit the sensor’s dimensions and limits its design.

Similarly, U.S. Patent 11,071,279 discloses placing a sensor inside a tag housing facing the earlobe as shown in FIG. 2D element 114. However the sensor does not allow for good contact with the ear and therefore cannot provide reliable steady heat flow. In addition because the sensor is inside the tag it is prone to damage if the tag is damaged.

Therefore, there is still a need for an improved method and system for providing good contact with an animals ear to measure its temperature. Further there is a need for the sensor to be protected from external mechanical strain and easily manufactured.

### SUMMARY

Compared to the above prior attempts, the present disclosure fulfills the above criteria and provides additional benefits that state of the art systems cannot provide.

The current device, system, and method provides for good contact of the sensor with the earlobe to capture heat from the animal to measure temperature by heat transfer of the animal’s ear to the sensor. The current device provides for protection of the sensor from external mechanical strain and efficient manufacturability by utilizing an encapsulated sensor that protrudes outwardly from the tag and contacts the ear of the animal.

In another aspect, the device provides for a mechanical arrangement of an animal ear tag which comprises, a temperature sensor disposed against the earlobe, capsulated in a protruding section of the tag. The tag section is pressed against the animal’s earlobe when the tag is mounted on the ear by a piercing assembly.

In yet another aspect, the device provides for a tag that collects temperature off a mammal’s earlobe comprising: at least one electronic circuit board at least one temperature sensor, coupled to the electronic circuit board a tag base member proximate to the earlobe, the base member coupled to said least one electronic circuit board, and having a back surface a piercing member for affixing the tag base to the earlobe; the piercing member having an elongated shape whereas the base member is affixed to the mammal’s ear by the piercing member. The at least one temperature sensor is disposed substantially parallel to the earlobe and proximate to the back surface of the tag facing the mammal’s ear. The distance of the sensor protruding from the back of the tag to the earlobe is determined by the length of the piercing member.

In another aspect, the temperature sensor of the device is in contact with a protruding section of the back surface of the tag. Depending on the implementation, the temperature sensor is in contact with a protruding section of the back surface and is made of a thermally conductive material. In other aspects, the temperature sensor is disposed on a printed circuit board, which is flexible, rigid or a combination thereof. The temperature sensor that is protruding out of the tag may be wirelessly connected or connected by wires to the printed circuit board inside the tag. Other combinations of the tag, sensor and printed circuit board are possible. Some of these combinations including having the piercing member integral with the tag so that the piercing member or sharp component is part of the tag.

In another aspect, the current device, system, and method provides for a finder transceiver (FT) that is either mobile or stationary or both. In one embodiment, the transmitting object is an animal carried tag, and the tag may be a single piece item, or an assembly. The FT may be, but is not necessarily, non-stationary or mobile. The tag may incorporate a power source, a processing component, a memory component, at least one sensor element, a receiver, a radio transmitter, or any combination thereof.

The FT device may include at least one directional antenna or at least one partially confined antenna (PCA). The FT has a body axis, aligned with the main antenna axis in case of a single antenna, or; aligned with the angle bisector of the angle between the two antennas most angularly distal from one another. This directional antenna is an antenna which radiates or receives greater power in specific directions in relating to its axis, as opposed to an omni antenna which reception or transmission levels are principally similar at all directions.

The directional antenna structure may incorporate a plurality of antenna elements and a directional receiving pattern; and may be connected to a radio frequency (RF) receiver. The directional antenna’s structure defined a yagi-type and/or patch-type and/or stripline-type antenna structure; or, wherein the plurality of antenna elements forms a linear phased array antenna structure including a plurality of antenna elements and a plurality of phase shifters configured to control the phase of a signal transmitted by each of the antenna elements; preferably the yagi-type antenna including: at least one reception electrode connected to RF receiver, a reflector electrode and one or more director electrodes.

In another aspect, a processor is further used with the FT device. The FT is coupled to a processor, either wirelessly or through wire connections, wherein the processor performs comparison of signals received through said at least two directional antennas or two PCA. The comparison may be of multiple signals received by said at least one directional antenna or PCAs over time.

In one aspect, based on the comparison and the signal power and trends of thereof, the FT, establishes an estimated directional orientation, estimated proximity , or a combination thereof, indicative of the tag’s relative position, and; preferably but not necessarily, outputs the tag’s estimated relative position, based on: (a) the estimated direction and estimated proximity to the FT, (b) the rate of a change in proximity, becoming more proximate or distal, as reflected in the trends of the received signal levels, or a combination thereof.

In another aspect, a method for establishing the position of a tag carried by an animal comprises steps of (a) receiving signals via at least one directional antenna or at least one PCA or combination thereof over time, and; (b) comparing said signals levels (RSSI) over time and the trend of said levels, for example, increase, decrease or steady, and; (c) determining the direction of the signal’s origin based on the signals levels, (d) determining the proximity trend based on RSSI level trends, (e) comparing the signals levels and the trend of said levels over time, and (d) via a user interface, providing an indication of the animal tag’s relative direction with respect to the finder-transceiver (FT).

In another aspect the piercing member is a separate component that passes through an orifice in the tag and is then capped with a snap fit or screwed on end cap. Both embodiments of the piercing mechanism have the sensor not contained within the shaft of the piercing mechanism for the benefits discussed herein.

### BRIEF DESCRIPTION OF THE DRAWINGS

To assist those of skill in the art in making and using the disclosed composition and method, reference is made to the accompanying figures, wherein:

FIG. 1 shows a photograph of the tag assembly in accordance with one embodiment of the present disclosure;

FIGS. 2A-2D show a structure of a tag including the housing parts with the sensor in a protrusion in accordance with one embodiment of the present disclosure;

FIGS. 3A-3C illustrate the structure of the tag including a piercing member as an accessory not part of the tag assembly that carries a sensor;

FIGS. 4A-4B show the structure of the tag including a piercing member that is part of the tag assembly that carries a sensor;

FIGS. 5A-5B show the structure of the tag including a piercing member that is part of the tag assembly that carries a sensor inside the piercing member;

FIGS. 6A-6C show a belt containing a Finder Transceiver (FT) device for finding a tag assembly that carries a sensor; and

FIGS. 7A-7B show a mobile and a stationary FT device for finding a tag assembly on an animal.

### DETAILED DESCRIPTION

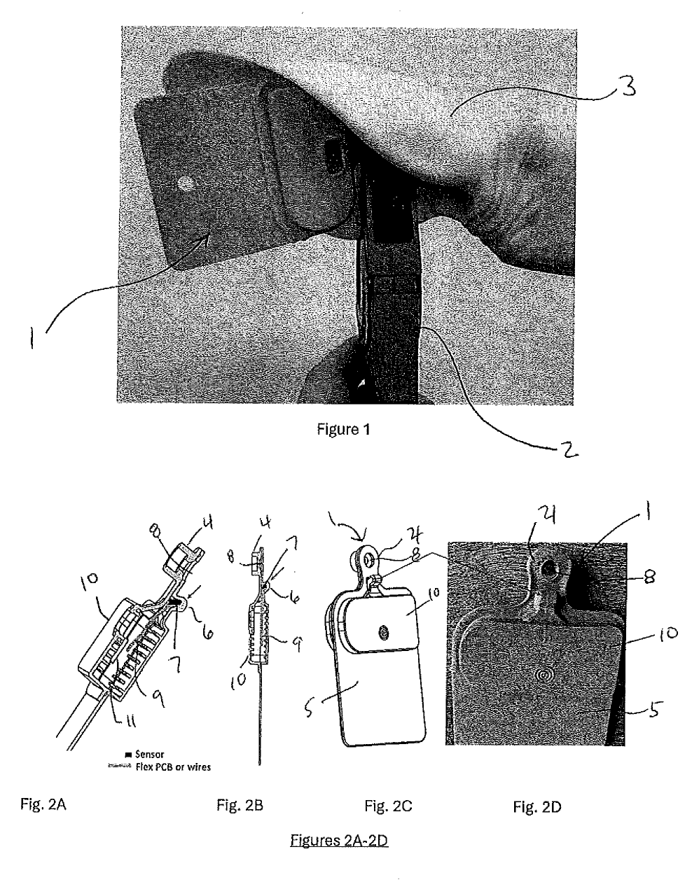

The invention includes, according to certain embodiments, systems and processes relates to a temperature tag assembly 1 as shown in FIG. 1. The tag 1 as shown in the figures and, depending on the implementation, is affixed to a mammal’s ear 3 by an affixing instrument 3 that depending on the embodiment may be a medical staple gun, crimper, pin or post injector and the like. Depending on the embodiment, the tag includes a holder 4 defining a hole 8 as shown in FIGS. 2A-2D The hole 8 is for receiving a piercing member 12. The piercing member, as further described herein, may or may not be part of the tag assembly 1. As shown in FIG. 2A, the hole 8 may contain various designs such as, but not limited, to bosses, ridges, snap fit designs, and the like to assist in securing the piercing member to the tag. Further shown in FIG. 2A-2D the tag may further include a base 5 for containing components of the tag and for allowing indicia or other markings to identify the mammal and/or the tag. A resilient protrusion 6 extends externally from the base, and may or may not be encapsulated. The protrusion contains a sensor 7 to allow the sensor to come into contact with the tissue of the mammal. The length required for the extension of the protrusion depends, in some embodiments on a length of a shaft of the piercing member. Preferably the protrusion 6 is at an angle relative to the base, such as but not limited to an angle between 0 to 90 degrees relative to the base.

The tag assembly 1 further includes a flexible printed circuit board (PCB) or wires 9 in communication with the sensor 7. The tag further includes an electronic holder or compartment 10 for holding electronic components and/or power source 11 such as a battery. The power source may or may not be solar powered, dry chemical battery, disposable or a rechargeable battery.

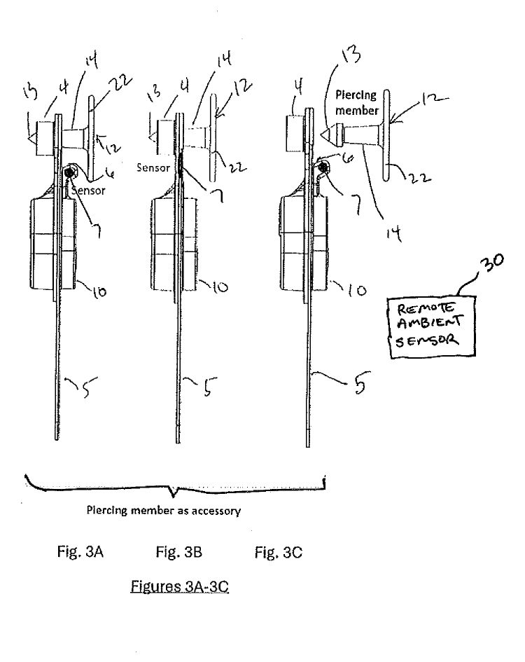

Adverting to FIGS. 3A-3C illustrated is a piercing member 12 that is not part of the tag 1 and is an accessory to the tag. Piercing member 12 further may include a neck or shaft of the piercing member 14, a piercing tip 13 and a base of the piercing member 22. The tip of the piercing member enters the holder 4 of the tag and connects with the ridges in hole 8 to secure the tag. The piercing tip is for puncturing through the mammal’s ear. In addition the piercing tip 13 and/or the neck 14 of the piercing member further includes grooves to function as a matching surface to ridges or snap fit designs in the holder 4 within the hole 8. The piercing member is attached to a back of the mammal’s ear and held by base 22 that allows the sensor 7 to come into contact with the tissue of the mammal at a front of the mammal’s ear. Other configurations of the piercing member are possible such as where the base 22 is in the front of the mammal’s ear and the sensor is in contact with the tissue of the mammal at the back of the mammal’s ear. As illustrated in FIGS. 3A and 3B, the sensor 7 may be utilized with or without the protrusion 6.

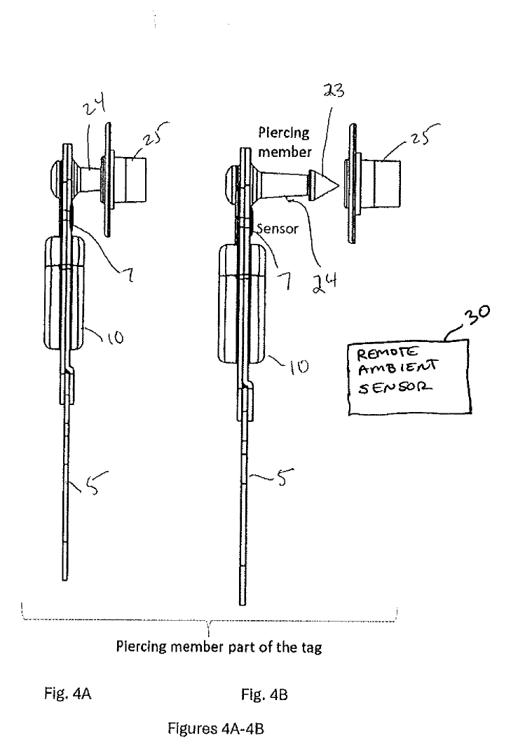

FIGS. 4A-4B illustrate the piercing member being integral with or a part of the tag 1. As shown the integral piercing member has a tip 23 and a neck 24. The tip 23 enters into holder 25. Again the neck 24 and/or tip 23 may further include grooves or ridges that match internal grooves or ridges in holder 25 to affix the tip 23 into holder 25. The sensor 7 may or may not include protrusion 6. Illustrated in this figure is the sensor 7 without the protrusion 6, however, this configuration may also include the protrusion 6 to hold the sensor 7.

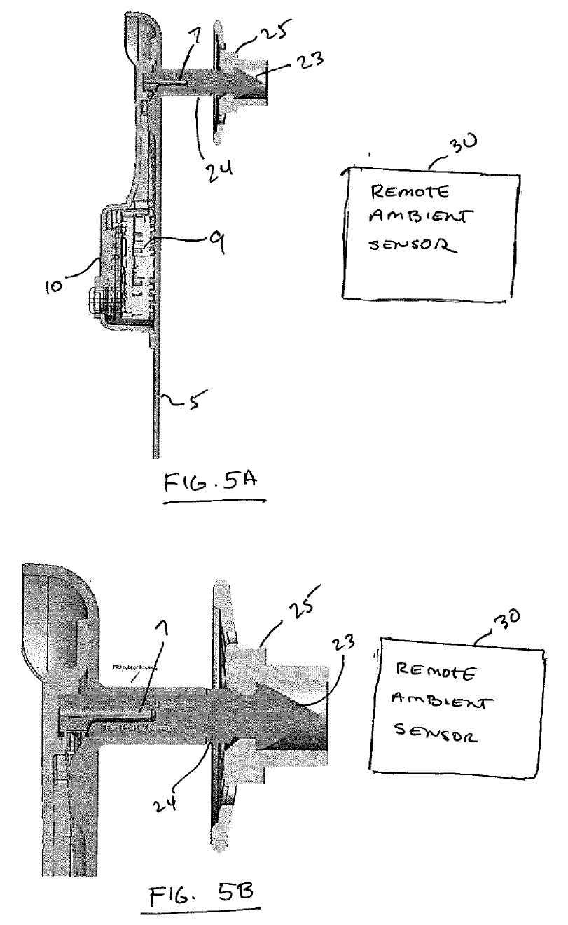

FIGS. 5A-5B illustrate the sensor inside the piercing member. As shown is a hollow piercing member that has a tip 23 and a neck 24. The tip 23 enters into holder 25. Again the neck 24 and/or tip 23 may further include grooves or ridges that match internal grooves or ridges in holder 25 to affix the tip 23 into holder 25. The sensor 7 is connected to the flexible printed circuit board (PCB) 9. A remote ambient sensor 30 is utilized to calculate the temperature of the animal. The remote ambient sensor 30 depending on the implementation may be a sensor separate from the tag and/or an independent weather source for an ambient temperature reading such as but not limited to an independent weather service, remote weather sensor, internet weather source, and the like. The temperature of the sensor and ambient temperature are both used to calculate the final temperature of the animal. When you have a remote ear tag sensor on a cow that measures temperature, the ambient temperature from a separate remote sensor is often used to improve the accuracy of the cow’s actual body temperature measurement. Ear tag sensors typically measure the skin or surface temperature at the ear, which can be influenced by the surrounding air temperature. If it’s cold outside, the ear surface temperature might be lower than the cow’s core body temperature. Conversely, if it’s hot, the ear temperature might be higher due to environmental heat. Therefore, the raw ear sensor reading needs to be adjusted or calibrated using the ambient temperature to better estimate the true body temperature of the cow. The ambient temperature is used in mathematical models or algorithms that correct the raw ear tag temperature reading.

For example, a common approach involves an equation such as: T_cow = a × T_ear_tag + b × T_ambient + c where a, b, and c are coefficients determined by experiments and calibration. Before deployment, researchers collect data of ear tag temperatures, ambient temperatures, and reference core body temperatures (like rectal temperature). They then create calibration curves that relate these variables. For health monitoring purposes, such as detecting fever, ambient temperature helps adjust the threshold values. For example, if it’s cold, a lower ear temperature might still indicate a fever once the ambient temperature is accounted for. Additionally, sudden drops or spikes in ear temperature readings caused by environmental changes such as wind, rain, or sun exposure can be identified and corrected by referencing ambient temperature. In summary, the ambient temperature is combined with the ear tag temperature reading through a model or calibration algorithm. This combined approach accounts for environmental influences and estimates a more accurate internal body temperature of the cow, which is critical for reliable health monitoring and early detection of illness remotely.

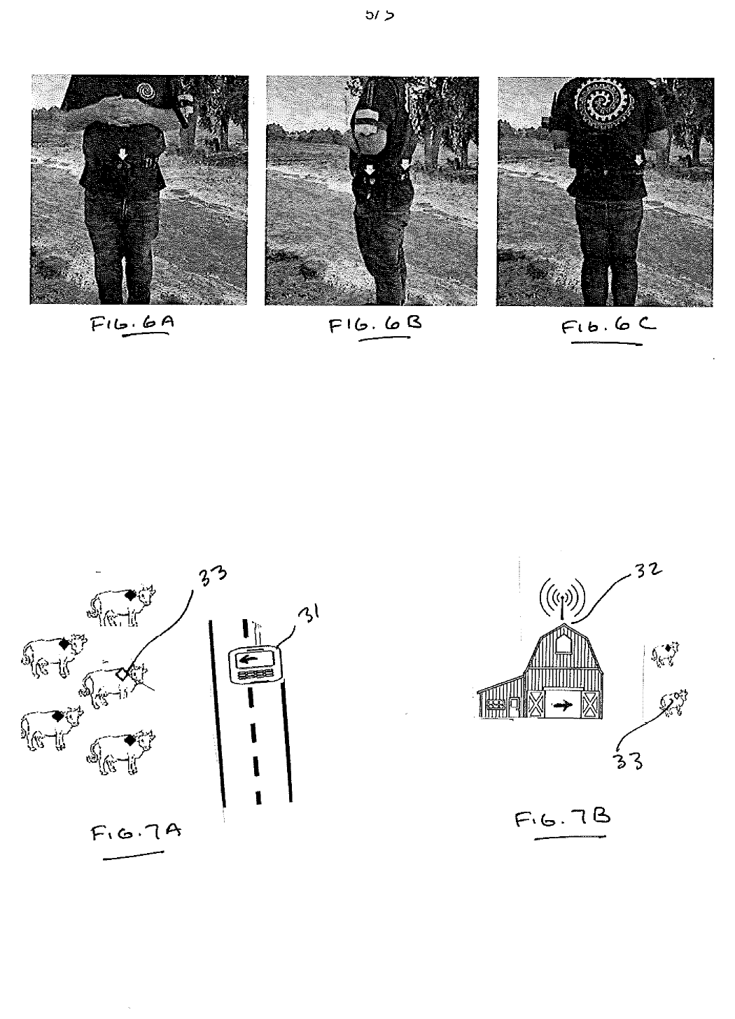

FIGS. 6A-6C illustrate the FT device in one embodiment on a belt of a user. This illustrates the FT may or may not be wearable. In another embodiment the FT device is on a saddle or other object that may be mobile or stationary. The FT device elements on the belt shown are disclosed herein as a PCA (Partially Confined Antenna), which are incorporated in the finder-transceiver (FT) on the belt. As previously described, receiving signals via at least one directional antenna or at least one PCA or combination thereof over time is the essence, which in some cases may involve either the plurality of PCAs embedded on a “belt” like wearable, and\or comprise some stationary PCAs. The belt is one way to implement, as other embodiments, including but not limited to horse mounting of the plurality of PCAs, and \or having some as stationary elements.

FIGS. 7A-7B illustrate the FT device for detecting the tag on an animal 33 may be mobile such as FT device 31 or stationary such as FT device 32. A stationary element of the FT device may also be part, or used in combination with, the mobile element of the FT device as a means to find the location of the tag. For example, both the mobile and stationary component shown in FIGS. 7A and 7B may be used in combination, so based on a mobile element of the FT device such as, but not limited to, the belt and a stationary FT device for example in a barn. The FT device utilizes the wearer of the mobile element as a barrier differentiating the receivers. Thus the direction of the tag may be readily identified.

Again the tag may or may not further contain a radio transceiver. An antenna, power source, a processing component, a memory component, at least one temperature sensor 7, a radio transmitter, or any combination thereof.

In one embodiment, the Tag is an animal carried tag, affixed to the animal’s ear as described herein. A directional antenna is an antenna which radiates or receives greater power in specific directions in relating to its axis, as opposed to an omni antenna which reception or transmission levels are principally similar at all directions. A directional antenna structure may incorporate a plurality of antenna elements and a directional receiving pattern; and may be connected to a radio frequency (RF) receiver. The directional antenna’s structure defined a yagi-type and/or patch-type and/or stripline-type antenna structure; or, wherein the plurality of antenna elements forms a linear phased array antenna structure including a plurality of antenna elements and a plurality of phase shifters configured to control the phase of a signal transmitted by each of the antenna elements; preferably the yagi-type antenna including: at least one reception electrode connected to RF receiver, a reflector electrode and one or more director electrodes.

In one embodiment, the tag is an animal carried tag, affixed to the animal’s ear. A directional antenna is an antenna which radiates or receives greater power in specific directions in relating to its axis, as opposed to an omni antenna which reception or transmission levels are principally similar at all directions. A directional antenna structure may incorporate a plurality of antenna elements and a directional receiving pattern; and may be connected to a radio frequency (RF) receiver. The directional antenna’s structure defined a yagi-type and/or patch-type and/or stripline-type antenna structure; or, wherein the plurality of antenna elements forms a linear phased array antenna structure including a plurality of antenna elements and a plurality of phase shifters configured to control the phase of a signal transmitted by each of the antenna elements; preferably the yagi-type antenna including: at least one reception electrode connected to RF receiver, a reflector electrode and one or more director electrodes.

Another way to create directional reception/transmission of an antenna is to use a at least Partially Confined Antenna (PCA), that is an antenna confined by at least one RF signal blocking element, interfering reception, or transmission from or towards certain direction while not interfering with reception or transmission from or towards another direction.

In both directional antenna and PCA, the direction with the greater reception of a transmission power, is defined as the Main Antenna Axis.

Depending on the embodiment, the FT device may include at least one directional antenna or at least one PCA. The FT has a body axis, aligned with the main antenna axis in case of a single antenna, or; aligned with the angle bisector of the angle between the two antennas most angularly distal from one another.

In order to direct a FT towards the Tag using a directional antenna or PCA, one has to perform an angular scanning motion, while monitoring the reception levels. It is anticipated that when the directional antenna or PCA is directed towards the transmitting object, the signal level will be at maximal level. To overcome a need to perform an angular scanning motion, the present invention utilizes an antenna arrangement comprising multiple directional antennas or PCAs physically positioned in different orientations.

In another embodiment, the FT device comprises at least two directional antennas or at least two PCA, wherein said antennas are arranged so that reception of a radio signal from in respective direction, shall differ from a same signal received in another respective direction.

The FT is coupled to a processor, said processor capable to perform comparison of signals received through said at least two directional antennas or two PCA. The comparison may be of multiple signals received by said at least one directional antenna or PCAs over time.

Based on the comparison and the signal power and trends of thereof, the FT, establishes an estimated directional orientation, estimated proximity , or a combination thereof, indicative of the tag’s relative position, and; preferably but not necessarily, outputs the tag’s estimated relative position, based on: (a) the estimated direction and estimated proximity to the FT, (b) the rate of a change in proximity, becoming more proximate or distal, as reflected in the trends of the received signal levels, or a combination thereof.

A momentary probable orientation of the Tag vs the FT, is corresponding to the orientation of the antenna which received the highest signal. In the event of said multiple antennas, whereas one of the antennas receiving substantially higher signal, comparing to said other antenna, then, the probable orientation of the Tag vs the FT, coincides with the highest signal’s antenna’ main axis. In the event said multiple antenna all receiving similar signal level; it is indicative of the Tag orientation being at a relative angle corresponding to the FT’s main body axis.

In one embodiment of the present invention, the FT comprising at least two visual indicating components, for example but not limited to LEDs. Each LED corresponds to one directional or PCA antenna’s main axis. The FT will light the LED responding the antenna receiving the highest signal. In another embodiment, where more than two antennas are used, the direction estimation’s resolution is increased according to the number of directional antennas or PCAs added.

The tag may be transmitting in one or more transmission power levels, and the processor coupled to the FT is configured to calculate a weighted average signal strength for the Tag’s direction and proximity establishment.

The processor may also change the weight for each power transmitted signal level along the position estimation process based on proximity or other considerations - for example, when the reception level is very low, the weight will be high for the higher transmission power, and when the reception level is very high, the weight will be high for the low transmission power. The aforesaid, is intended to maintain the weighted average of the signal levels, within a predefined scale limits (Auto Gain Control).

The FT is capable of estimating a proximity according to the reception signal’s power, the higher the power, the higher proximity. In one embodiment, the FT uses the rate of change in reception signal power, a higher rate of change, being indicative of higher proximity, based on a general principal, that reception power, is proportional to the inverse square of the distance between a transmitter and a receiver. Thus, for a given displacement of the FT towards the Tag the higher rate of change of the reception of said signal power, is indicative of a higher proximity of the FT to the Tag.

Indications of reception’s signal power may be derived from: RSSI, direct signal power, or quantification and comparison of received data vs the transmitted data. For example; one may send a 30 of packets each containing 640 bytes, yet only 20 packets are received, which is indicative of a medium reception power level, comparing to receiving of 29 packets indicative of a high reception.

The finder-transceiver is coupled to an audio, visual or tactile device, for presenting to a user, directional and proximity indications of the tags physical position, said device may be, but not limited to, a mobile communication device for example a smartphone, or a dedicated audio, visual or tactile directional indication device.

A method for establishing the position of a Tag carried by an animal comprises steps of (a) receiving signals via at least one directional antenna or at least one PCA or combination thereof over time, and; (b) comparing said signals levels (RSSI) over time and the trend of said levels i.e. increase, decrease or steady, and; (c) determining the direction of the signal’s origin based on the signals levels, (d) determining the proximity trend based on RSSI level trends, (e) comparing the signals levels and the trend of said levels over time, and (d) via a user interface, providing an indication of the animal tag’s relative direction with respect to the finder-transceiver.

In an embodiment of the present invention, the finder-transceiver and the tag, may be used to: (a) identify presence of Tag in predetermined proximity to the finder-transceiver or (b) to another tag; for determining a parameter repressing movement characteristics of tags with respect to one another or to the finder-transceiver, or; the movement characteristics of plurality of tags with respect to one another independently. Changes in tag’s position may indicate level of moving about of the Tag and thus the animal carrying it. The Tag may hold identification information remotely precepted by the finder-transceiver, autonomously, in response to a signal sent by the finder-transceiver, or a combination thereof.

In still another embodiment of the present invention, the finder-transceiver comprises a processing unit capable of computing characteristics of a received radio signal received from a tag, by following steps required for direction determining: (a) receiving a sequence of at least two time spaced signals, (b) determining RSSI levels over time (c) determining changes in RSSI levels over said time, (d) determining whether said sequential changes in RSSI levels over time represent an increase of decrease in said RSSI levels. In addition, said characteristics of a received radio signal received from a Tag may establish the proximity trend computing changes in the derivative of said RSSI levels over time of a signals from the tag, indicative of (a) the tag’s proximity to the finder-transceiver, (b) the tag’s principally moving towards or away from said finder-transceiver.

The Tag may be transmitting in one or more transmission power levels, and the processor is configured to calculate a weighted average signal strength for the Tag’s direction and proximity establishment.

The processor may also change the weight for each power transmitted signal level along the position estimation process based on proximity or other considerations - for example, when the reception level is very low, the weight will be high for the higher transmission power, and when the reception level is very high, the weight will be high for the low transmission power. The previously mentioned, is intended to maintain the weighted average of the signal levels, within a predefined scale limits (Auto Gain Control).

A method for establishing the position of a Tag carried by an animal comprises steps of (a) receiving signals via at least one directional antenna or at least one PCA or combination thereof over time, and; (b) comparing said signals levels (RSSI) over time and the trend of said levels i.e. increase, decrease or steady, and; (c) determining the direction of the signal’s origin based on the signals levels, (d) determining the proximity trend based on RSSI level trends, (e) comparing the signals levels and the trend of said levels over time, and (d) via a user interface, providing an indication of the animal tag’s relative direction with respect to the finder-transceiver.

The method may also comprise the following steps; extending leads for connecting the sensor to a controller, and coating the sensor with an adhesive. In a preferred embodiment of the method, the sensor is and SMD sensor, mounted on a flexible printed circuit FPC board , the sensor and the FPC are at least partially coated with adhesive, wherein the adhesive at least partially coats the sensor and the flexible circuit board. In a preferred embodiment, the leads are either; integrated in the FPC, protruding wires, or a combination thereof.

In an embodiment of the present invention, the finder-transceiver and the tag, may be used to: (a) identify presence of Tag in predetermined proximity to the finder-transceiver or (b) to another tag; for determining a parameter repressing movement characteristics of tags with respect to one another or to the finder-transceiver, or; the movement characteristics of plurality of tags with respect to one another independently. Changes in tag’s position may indicate level of moving about of the Tag and thus the animal carrying it. The Tag may hold identification information remotely precepted by the finder-transceiver, autonomously, in response to a signal sent by the finder-transceiver, or a combination thereof.

In still another embodiment of the present invention, the finder-transceiver comprises a processing unit capable of computing characteristics of a received radio signal received from a tag, by following steps required for direction determining: (a) receiving a sequence of at least two time spaced signals, (b) determining Received Signal Strength Indicator (RSSI) levels over time (c) determining changes in RSSI levels over said time, (d) determining whether said sequential changes in RSSI levels over time represent an increase of decrease in said RSSI levels. In addition, said characteristics of a received radio signal received from a Tag may establish the proximity trend computing changes in the derivative of said RSSI levels over time of a signals from the tag, indicative of (a) the tag’s proximity to the finder-transceiver, (b) the tag’s principally moving towards or away from said finder-transceiver. RSSI is a measure of the power level of a wireless signal received by a device. It is typically expressed as a negative number, where 0dBm indicates the best signal strength ad -110dBm indicates the weakest or no signal.

Use of RSSI levels may have limited sensitivity when establishing proximity. Signals different in dBm levels of, from same proximity to an LCX for example, may be subject to reflection’s artifacts, especially when the signal is of higher dBm levels.

The present invention also relates to a system and methods for an Animal’s Attending Identification (AAI) wherein proximity to a feeding bunk, water truffe or other place of interest. The eating and drinking behavior of an animal are known to be indicative of animal’s health and thus of interest to track. In addition, quantification of feeding behavior, is of interest with regards to managing feed related expenditure for feeding an individual animal.

In still another embodiment of the present invention, the Tag holds information representing its presence in proximity to certain objects such as a feeding trough for the purpose of establishing feeding duration. To that end, the Tag must transmit extensively over time, to ensure that its transmissions are received when it approaches the feeding area, which is inefficient in terms of power consumption. However, the tag may also contain a rechargeable battery that is wirelessly charges, for example, when the animal is eating at a feeding trough.

Mobile carried radio transmitting tags, such as animal tags, are limited in their ability to carry large batteries ability to carry large power sources such as battery, whereas stationary transceivers, allow for either stationary power feed from main, solar, or otherwise large electric power holding devices. It is the purpose of the present invention to disclose a system designed in such way that the power use of the Tag is minimal.

The tag may transmit the aggregated data collected, for example events of presence in proximity to the feeding trough and/or related animal temperature, and relating characteristics such as timing and duration, as well as, but not necessarily, information concerning temperature measured using a sensor within the Tag.

Depending on the embodiment of the present invention, the Tag holds data indicative of the health state of an animal, and said data is transmitted wirelessly according to a regimen. The Tag may autonomously determine the regimen, and\or in respond to an external triggering, determining for example but not limited to the Tag’s transmission frequency, triggering regimen, level, data content or any combination thereof. A triggering criterion for a regimen, may be, but is not limited to (a) a data value threshold such a temperature (b) proximity events such as closeness to a feeding trough, (c) state if the memory component in the Tag (d) state of the battery in the tag, or (e) other computed value and any combination thereof.

As tags mounted on animals may be subjected to mechanical impact, and the mechanical impact may compromise integrity of electronic hardware. The present invention comprises an animal tag made of resilient material such as but not limited to a substantially flexible material such a thermoplastic urethane (TPU) rubber, and a substantially rigid material such a polyurethane, styrene-butadiene rubber, nylon based rubber neoprene, natural rubber, and any combination thereof.

The tag may be affixed to the ear, and fixing may be using a structure comprising the piercing member 12 and a holder 4 (non-integral piercing member tag), or the piercing tip member 23 may be integrated with the tag (integral piercing member tag). In one embodiment of the present invention, the sensor is disposed in the tag. The sensor may be disposed substantially on one side of an ear with the tag (such as the front), and the holding mechanism for the piercing member disposed in a principally opposite side of the ear (such as the back) opposite the electronic hardware, and vice versa.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A temperature sensing earlobe tag and based system, comprising:
a tag base housing having a front surface and a back surface, the tag base positioned proximate to an earlobe;
an electronic circuit board disposed within the tag base housing;
a temperature sensor connected to the electronic circuit board, the temperature sensor disposed inside a piercing member;
wherein the piercing member is for affixing the tag base housing to the earlobe, the piercing member having an elongated shape;
a remote ambient temperature sensor or independent source for an ambient temperature reading utilized in calculating the temperature of an animal wearing the tag base.

2. The tag and based system of claim 1, wherein the temperature sensor is made of a thermally conductive material.

3. The tag and based system of claim 2, wherein the thermally conductive material is selected from a group consisting of copper, silver, gold, aluminum nitride, silicon carbide, aluminum, tungsten, graphite, zinc, and any combination thereof.

4. The tag and based system of claim 1, wherein the electronic circuit board is flexible, rigid or a combination thereof, and the temperature sensor is disposed thereon.

5. The tag and based system of claim 1, wherein the temperature sensor is connected to the electronic circuit board by a wire and/or a pin.

6. The tag and based system of claim 1, wherein the tag base housing further includes a protective cover that is either rigid or flexible.

7. The tag and based system of claim 1, wherein the tag stores data indicative of a health state of an animal, and the data is transmitted wirelessly according to a regimen.

8. The tag and based system of claim 7, wherein the regimen is autonomously determined by the tag, and\or in respond to an external triggering device.

9. The tag and based system of claim 8 further includes a processor, and the processor performs a comparison of signals received through the at least two directional antennas or the at least one partially concealed antenna (PCA), and the comparison is of multiple signals received by said at least one directional antenna or the at least one PCA over time.

10. The tag and based system of claim 1 further including a finder transceiver (FT) for locating an animal wearing the tag.

11. The tag and device of claim 1, wherein the temperature sensor is connected by wires to said printed circuit board.

12. The tag and device of claim 1, wherein the temperature sensor is wirelessly connected.

13. A temperature sensing earlobe tag and based system, comprising:
a tag unit attached to a livestock for collecting data relating to one or more livestock behavioral patterns;
said tag system unit further having at least one transmitter;
a finder transceiver (FT) device remotely disposed from the tag unit and reading transmissions from the tag unit, wherein the FT is mobile and/or stationary, and the FT device includes at least one directional antenna or at least one partially concealed antenna (PCA); and
wherein the data is transmitted or received from the tag unit to the finder transceiver, and the directional antenna radiates or receives greater power in specific directions in relating to an axis of the directional antenna as opposed to an omni antenna where reception or transmission levels are similar at all directions.

14. The tag and based system of claim 13, wherein the tag holds data indicative of a health state of an animal, and the data is transmitted wirelessly according to a regimen.

15. The tag and based system of claim 14, wherein the regimen is autonomously determined by the Tag, and\or in response to an external triggering.

16. The tag and based system of claim 15, wherein the external triggering includes a data value threshold such a temperature, a leaky coaxial cable antenna (LCX) proximity event, a state of a memory component in the Tag, a state of the battery in the Tag, a computed value, or any combination thereof.

17. The tag and based system of claim 13, wherein the Tag unit further includes a power source, a processing component, a memory component, at least one sensor element, a receiver, a radio transmitter, or any combination thereof.

18. The tag and based system of claim 13, wherein the directional antenna is connected to a radio frequency (RF) receiver, and the directional antenna is a yagi-type antenna structure, patch-type antenna structure, a stripline-type antenna structure, or any combination thereof.

19. The tag and based system of claim 13, wherein the FT device further includes a processor, and the processor performs a comparison of signals received through the at least two directional antennas or the at least one partially concealed antenna (PCA), and the comparison is of multiple signals received by said at least one directional antenna or the at least one PCA over time.

20. A method using a temperature sensing earlobe tag and based system comprises steps of:
receiving on a finder-transceiver (FT) device a non-transitory signal from a tag via at least one directional antenna or at least one PCA or combination thereof over time;
comparing a non-transitory signal levels (Received Signal Strength Indicator-RSSI) over time and comparing a trend of the signal levels, wherein the trend shows an increase, decrease or steady signal level;
determining a direction of the signal origin based on the signals levels;
determining a proximity trend based on RSSI level trends;
comparing signals levels and the trend of levels over time; and
providing an indication via a user interface of an animal tag’s relative direction with respect to the finder-transceiver.
